(19) United States
(12) Patent Application Publication
(10) Pub. No.: US 2003/0103113 A1
(43) Pub. Date: Jun. 5, 2003

(54) Thermal head

(75) Inventor: Hiroshi Kobayashi, Fukushima-ken (JP)

Correspondence Address: Hrinks Hofer Gilson & Lione, P.O. Box 10395, Chicago, IL, 60610, US

(73) Assignee: Alps Electric Co., Ltd.

(21) Appl. No.: 10/303,512

(22) Filed: Nov. 25, 2002

(30) Foreign Application Priority Data
Dec. 3, 2001 (JP) 2001-368735

(51) Int. Cl. B41J 2/05

(52) U.S. Cl. 347/64

(57) ABSTRACT

In a thermal head capable of performing printing of high quality while preventing foreign matters such as dirt or the like from accumulating in a portion, on which a heat reserving layer is formed, at the time of printing, the heat reserving layer comprising a projection formed by partially projecting a surface of the layer and having a top, the projection being provided on a surface thereof with heating elements, the projection being shaped in cross section in a direction perpendicular to a direction of arrangement of the heating elements to form an inclined surface on one surface side, which is formed to be lower than the other surface side. The projection is formed so that a height thereof from the one surface side is 5 to 50 μm.

### BACKGROUND OF THE INVENTION

The invention relates to a thermal head for use in thermal printers, and more particularly, to a thermal head capable of preventing degradation in print quality, caused by adherence of dirt or the like.

Generally, a thermal head as a recording head mounted on a thermal printer or the like comprises a plurality of heating elements composed of a heating resistor and aligned in a row on a substrate, and the heating elements are selectively energized according to printing information to generate heat, thereby melting ink on an ink ribbon to heat transfer the same to regular paper, paper for OHP (overhead projector), or the like, or to cause a thermal recording paper to take color, so that printing on recording media of various kinds is performed.

With such conventional thermal head, it is general as shown in FIG. 3 that a heat reserving layer 12 is formed on an upper surface of a radiating substrate 11 and a projection 12b is formed on an upper surface of the heat reserving layer 12 and near one end 11a, which constitutes a right side end of the substrate 11, to project a predetermined height.

Also, a heating resistor 13 is laminatingly formed on the upper surface of the heat reserving layer 12, and a common electrode 14 and an individual electrode 15 are formed on the left and right of the heating register 13 to supply electric power energy to the heating resistor 13.

A plurality of heating elements 13a are aligned in a dot-shaped manner and formed in a location between the common electrode 14 and the individual electrode 15 of the heating resistor 13.

Also, protective layers (not shown) are laminatingly formed on upper surfaces of the heating elements 13a, the common electrode 14 and the individual electrode 15 to prevent oxidation and abrasion of the heating elements 13a, and the respective electrodes 14, 15.

Also, as shown in FIG. 4, a driver IC is arranged on a left side of the projection 12b in the figure and near the other end 11b of the substrate 11 to be connected to the common electrode 14 and the individual electrode 15.

Also, a terminal portion 17 formed from a FPC (flexible substrate) or the like is taken out from the other end 11b of the substrate 11.

With such conventional thermal head, the substrate 11 is mounted on a head mount (not shown) to be mounted on a thermal printer for printing, at which the head mount is turned to bring the thermal head into pressure contact with a platen (not shown), whereby the heating elements 13a can be brought into pressure contact with, for example, an ink ribbon 18.

In the case where a printer mounting thereon the conventional thermal head described above is a thermal transfer printer, the thermal head 11 is lowered to bring the heating elements 13a into pressure contact with the ink ribbon 18 and to move the thermal head 11 in a direction indicated by an arrow A.

Then, the heating elements 13a is caused on the basis of printing information to selectively generate heat to heat the ink ribbon 18, whereby ink on the ink ribbon 18 is transferred to a recording sheet 19 to afford printing characters, images or the like on the recording sheet 19.

Also, with a thermal transfer printer of line type, printing on the recording sheet 19 can be performed while moving the ink ribbon 18 and the recording sheet 19 in a direction indicated by an arrow B without moving the thermal head.

With conventional thermal heads, however, recesses 12c, 12d are produced on the surface of the heat reserving layer 12 and on right and left feet of the projection 12b of a predetermined height in the figure.

Therefore, when ink in the ink ribbon 18 is transferred to the recording sheet 19 placed on a platen (not shown) for printing while the thermal head 11 with its head lowered is moved in the direction of the arrow A, it is feared that foreign matters, such as fine dirt or the like, attaching to the ink ribbon 18 accumulate in the recess 12c on a left side of the heating elements 13a in the figure and upstream of the projection 12b in the direction of movement indicated by the arrow A.

When foreign matters such as dirt or the like accumulate in the recess 12c on the left side of the heating elements 13a in the figure as described above, it is feared that striped white lines or the like are generated on a picture image printed on the recording sheet 19 under the influence of dirt or the like to cause degradation in quality of printing.

Also, in the case where printing is performed while the ink ribbon 18 and the recording sheet 19 are moved in the direction of the arrow B and without moving the thermal head 11, it is feared that foreign matters such as dirt or the like accumulate in the recess 12c on the left side of the heating elements 13a in the figure.

### SUMMARY OF THE INVENTION

The invention has been thought of in view of the above problem, and has its object to provide a thermal head capable of performing printing of high quality by preventing foreign matters such as dirt or the like at the time of printing to accumulate in a location where a heat reserving layer is formed.

The invention provides, as first solving measures for solving the above problem, a thermal head comprising a heat reserving layer formed on a surface of a substrate, a plurality of heating elements formed on an upper surface of the heat reserving layer, an individual electrode and a common electrode for supplying electricity to the heating elements, and a protective layer covering at least upper surfaces of the heating elements, the individual electrode and the common electrode, and wherein the heat reserving layer comprise a projection formed by partially projecting a surface of the layer, the heating elements being provided on a surface of the projection, and the projection is shaped in cross section in a direction perpendicular to a direction of arrangement of the heating elements to form an inclined surface on one surface side thereof, the other surface side thereof being formed to be flat in substantially the same height as that of a top of the projection.

Also, as second solving measures for solving the above problem, a height of the projection from the one surface side is 5 to 50 μm.

Also, as third solving measures for solving the above problem, the common electrode is formed on the one surface side and the individual electrode is formed on the other surface side.

### BRIEF DESCRIPTION OF THE DRAWINGS

FIG. 1 is a cross sectional view showing an essential part of a thermal head according to the invention;

FIG. 2 is a schematic view showing the printing operation performed by the thermal head according to the invention;

FIG. 3 is a cross sectional view showing an essential part of a conventional thermal head; and

FIG. 4 is a schematic view showing the printing operation performed by the conventional thermal head.

### DETAILED DESCRIPTION OF PREFERRED EMBODIMENTS

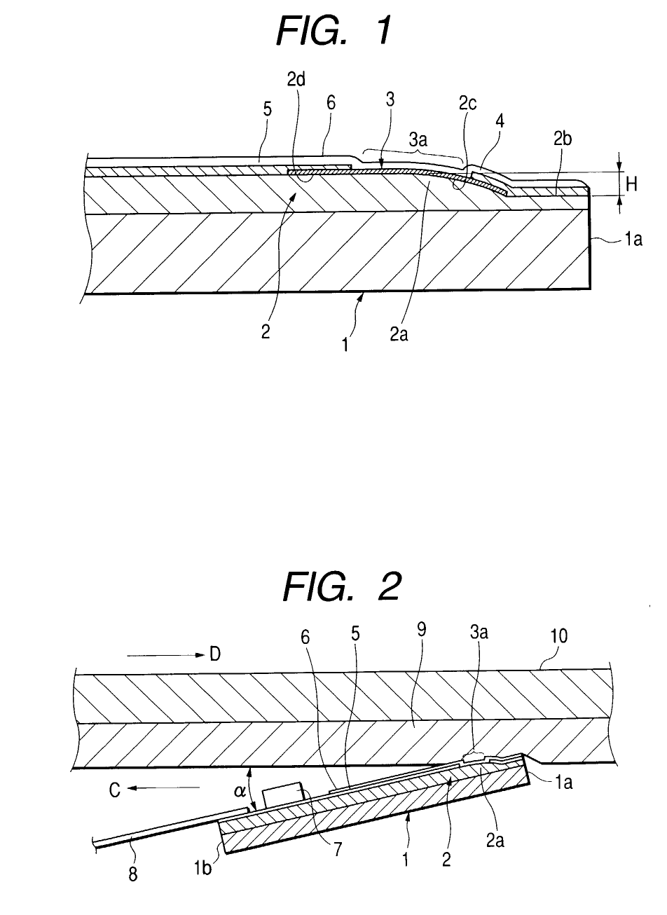

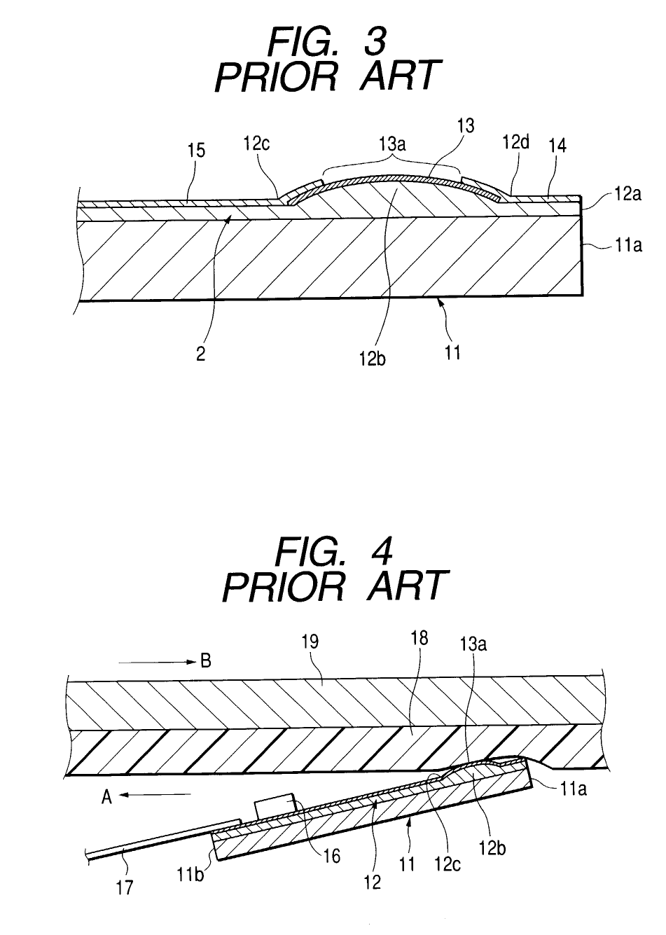

A thermal head according to the invention will be described below with reference to the drawings. FIG. 1 is a cross sectional view showing an essential part of a thermal head according to the invention, and FIG. 2 is a schematic view showing the printing operation performed by the thermal head according to the invention.

First, the thermal head according to the invention comprises, as shown in FIG. 1, a substrate 1 having a good heat dissipation and a heat reserving layer 2 composed of a glaze having a good heat reserving quality and formed on an upper surface of the substrate 1.

A photolithographic technique or the like is used to partially project a surface of the heat reserving layer 2 to form a projection 2a.

The projection 2a is shaped in cross section in a direction perpendicular to a direction of arrangement of heating elements 3a described later to form an inclined surface 2c on one surface side 2b disposed on a right side in the figure, the one surface side 2b being formed to be lower than the other surface side 2d disposed on a left side of the projection 2a in the figure.

Further, the projection 2a is formed by the inclined surface 2c to be gently inclined toward the one surface side 2b from the other surface side 2d. Therefore, the heat reserving layer 2 is shaped in cross section to be made stepwise by the inclined surface 2c.

Also, the other surface side 2d of the projection 2a is formed flat in substantially the same level as that of the projection 2a.

The projection 2a is formed near one end la being a right end of the substrate 1 in the figure. Also, the projection 2a is formed such that a height H from the one surface side 2b is in the range of 5 to 50 μm.

Also, a heating resistor 3 formed from Ta-N, Ta-SiO2 or the like is laminatingly formed on an upper surface of the heat reserving layer 2 by means of sputtering or the like.

Also, sputtering of Al, Cu, Au or the like and the photolithographic technique are used to laminate and pattern form a common electrode 4 on the inclined surface 2c and an individual electrode 5 on the other surface side 2d, which electrodes supply electric power energy to the heating resistor 3, on the upper surface of the heating resistor 3.

Besides, a portion interposed between the respective electrodes 4, 5 of the heating resistor 3 is aligned in a dot-shaped manner to provide a plurality of heating elements 3a.

Formed on upper surfaces of the heating resistor 3, the common electrode 4, and the individual electrode 5 by means of sputtering or the like to cover them with a predetermined thickness are a protective layer 6 formed from a hard ceramic such as Si-O-N, SiAlON or the like having excellent oxidation resistance and abrasion resistance for preventing oxidation and abrasion of the heating resistor 3, the common electrode 4, and the individual electrode 5.

Also, a driver IC 7 to be connected to the common electrode 14 and the individual electrode 15 is arranged on a left side of the heating elements 3a and on the heat reserving layer 2 near the other end 1b of the substrate 1.

The driver IC 7 is adapted to control voltage of current-carrying pulse supplied to, for example, the plurality of heating elements 3a to control the calorific power of the heating elements 3a.

Also, an external terminal 8 formed from a FPC (flexible substrate) or the like and connected to a terminal of the driver IC 7 is taken out from the heat reserving layer 2 near the other end 1b of the substrate 1.

Such thermal head according to the invention is mounted on a head mount (not shown) having a good heat dissipation so that heat accumulated in the heat reserving layer 2 during printing is dissipated through the substrate 1.

Also, the head mount is supported on a carriage (not shown) on a side of a printer to be able to turn. In the case where a printer making use of the thermal head according to the invention is a thermal transfer printer, the head mount is turned whereby the thermal head is lowered in a head-down manner to enable the heating elements 3a to come into pressure contact with an ink ribbon 9.

In a state, in which the thermal head 1 is lowered in a head-down manner, the carriage (not shown) is moved to move the thermal head in a direction indicated by an arrow C and selective energizing of the heating elements 3a on the basis of printing information causes the heating elements 3a to generate Joule heat for selective heating.

Such heating of the heating elements 3a causes selective heating of the ink ribbon 9, so that ink (not shown) in the ink ribbon 9 is transferred to be able to print characters, picture image or the like on a recording sheet 10 disposed on a platen (not shown).

At the time of such printing, a pressure contact angle α of the thermal head 1 relative to the recording sheet 9 is set in the range of 1 to 30 degrees.

Further, since a top of the projection 2a of the heat reserving layer 2 and the other surface side 2d are formed in substantially the same level, the recess 12c as illustrated in relation to the conventional thermal head 11 can be dispensed with.

Therefore, even if foreign matters such as dirt or the like are present on the surface of the recording sheet 9 when the thermal head lowered in a head-down manner is moved in the direction of the arrow C, the heating elements 3a can get over such foreign matters, so that such foreign matters will not remain and accumulate in a particular location on the thermal head 1.

Also, the pressure contact angle a of the thermal head relative to the recording sheet 10 is set to be in the range of 1 to 30 degrees, whereby the heating elements 3a formed over the gently inclined surface 2c can be efficiently brought into pressure contact with the ink ribbon 9 or a thermosensible paper (not shown),and so load of pressure contact exerted by the thermal head 1 can be concentratedly applied on the heating elements 3a. Therefore, it is possible to perform printing of high quality.

Also, in the case where the thermal head is of line head, type, picture images such as characters or the like can be printed on a recording sheet 10 by, for example, moving the ink ribbon 9 and the recording sheet 10 in a direction indicated by an arrow D without moving the thermal head.

Alternatively, with a direct thermal printer, the heating elements 3a are caused to come into direct pressure contact with a thermosensible paper (not shown) whereby the thermosensible paper is made to take color, thus enabling printing.

In addition, the heat reserving layer 2 may be formed such that the one surface side 2b of the projection 2a erects directly from the surface of the substrate 1.

With the thermal head according to the invention, since the projection is shaped in cross section in a direction perpendicular to a direction of arrangement of the heating elements to form the inclined surface on the one surface side and to form the other surface side in substantially the same level as that of the top surface of the projection, possible foreign matters, such as fine dirt or the like, present at the time of printing will not remain on the one surface side.

Therefore, it is possible to print a picture image of high print quality, in which no white lines or the like are generated under the influence of foreign matters or the like.

Also, since the thermal head according to the invention is formed such that a height H of the top of the projection from the one surface side is 5 to 50 μm, it is possible to prevent foreign matters such as dirt or the like from accumulating on a foot of the other surface side.

Also, since the common electrode is formed on the one surface side and the individual electrode is formed on the other surface side being flat, a pattern configuration can be enhanced in accuracy and minute patterning is possible. Thereafter, it is possible to process a thermal head of high resolution.

What is claimed is:

1. A thermal head comprising a heat reserving layer formed on a surface of a substrate, a plurality of heating elements formed on an upper surface of the heat reserving layer, an individual electrode and a common electrode for supplying electricity to the heating elements, and a protective layer covering upper surfaces of the heating elements, the individual electrode and the common electrode, and wherein the heat reserving layer comprise a projection formed by partially projecting a surface of the layer, the heating, elements being provided on a surface of the projection, and the projection is shaped in cross section in a direction perpendicular to a direction of arrangement of the heating elements to form an inclined surface on one surface side thereof, the other surface side thereof being formed to be flat in substantially the same height as that of a top of the projection.

2. The thermal head according to claim 1, wherein a height of the projection from the one surface side is 5 to 50 μm.

3. The thermal head according to claim 1, wherein the common electrode is formed on the one surface side and the individual electrode is formed on the other surface side.
